(19) United States
(12) Patent Application Publication
(10) Pub. No.: US 2016/0066013 A1
(43) Pub. Date: Mar. 3, 2016

(54) PORTABLE AND PERSONALIZED PASSENGER INFOTAINMENT SYSTEM IN CONNECTED CAR

(71) Applicant: Samsung Electronics Co., Ltd., Suwon-si (KR)

(72) Inventors: Zhiyun LI, Kenmore, WA (US); Jiaming LIU, Issaquah, WA (US); Chenxi ZHAO, Seattle, WA (US)

(21) Appl. No.: 14/468,790

(22) Filed: Aug. 26, 2014

(51) Int. Cl. H04N 21/414; H04N 21/44; H04N 21/466; H04N 21/41; H04N 21/2668

(52) U.S. Cl. CPC H04N 21/41422; H04N 21/4126; H04N 21/2668; H04N 21/4668; H04N 21/44008

(57) ABSTRACT

An apparatus and method of providing portable and personalized infotainment via an in-vehicle system of a vehicle from an infotainment content provider is provided. The method includes registering at least one mobile device with the in-vehicle system of the vehicle upon the at least one mobile device entering a defined location about the vehicle, receiving infotainment content at the at least one registered mobile device via the in-vehicle system of the vehicle while the at least one registered mobile device is within the defined location about the vehicle, and receiving the infotainment content at the at least one registered mobile device via another network upon the at least one mobile device leaving the defined location about the vehicle.

### TECHNICAL FIELD

The present disclosure relates to a connected car infotainment content system. More particularly, the present disclosure relates to providing portable and personalized access to infotainment content initiated by the connected car.

### BACKGROUND

Currently, a connected car system provides infotainment content to occupants of a car or other vehicle. The infotainment content is provided to the occupants via a head unit that may include a display or displays.

Accordingly, an apparatus and a method thereof that provides individualized content to a plurality of occupants of the car or other vehicle.

### SUMMARY

Aspects of the present disclosure are to address at least the above-mentioned problems and/or disadvantages and to provide at least the advantages described below. Accordingly, a method of providing portable and personalized infotainment via an in-vehicle system of a vehicle from an infotainment content provider is provided.

In accordance with an aspect of the present disclosure, a method of providing portable and personalized infotainment via an in-vehicle system of a vehicle from an infotainment content provider is provided. The method includes registering at least one mobile device with the in-vehicle system of the vehicle upon the at least one mobile device entering a defined location about the vehicle, registering at least one mobile device with the infotainment content provider upon the at least one mobile device entering a defined location about the vehicle, receiving infotainment content at the at least one registered mobile device via the in-vehicle system of the vehicle while the at least one registered mobile device is within the defined location about the vehicle, and receiving the infotainment content at the at least one registered mobile device via another network upon the at least one mobile device leaving the defined location about the vehicle.

In accordance with an aspect of the present disclosure, a system for providing portable and personalized infotainment is provided. The system includes an in-vehicle system comprising a processor and sensor, the in-vehicle system configured to determine an entry of at least one of a passenger and a driver of a vehicle and to identify a mobile device of the at least one of the passenger and the driver, and an infotainment server configured to receive information of the mobile device and register the mobile device and to transmit infotainment content to the mobile device, a type of infotainment content transmitted to the mobile device determined based upon whether the user of the mobile device is one of a passenger and a driver of the vehicle. The mobile device receives the infotainment content via the in-vehicle system while the mobile device is within the vehicle, and the mobile device receives the infotainment content via another network when the mobile device is outside of the vehicle.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 illustrates a network environment including an electronic device according to various embodiments of the present disclosure.

FIG. 2 illustrates a simplified structure of a vehicle infotainment content system according to an embodiment of the present disclosure.

FIG. 3 illustrates an infotainment content server for providing infotainment content according to an embodiment of the present disclosure.

FIG. 4 illustrates a network diagram of a vehicle infotainment content system that is capable of connecting with a mobile terminal according to an embodiment of the present disclosure.

FIG. 5 is a flowchart of a method of providing infotainment content according to an embodiment of the present disclosure.

FIG. 6 is an illustration of a mobile device receiving infotainment content according to an embodiment of the present disclosure.

FIGS. 7A and 7B are illustrations of a mobile device responding to an end of receiving infotainment content message according to an embodiment of the present disclosure.

FIG. 8 illustrates a block diagram of hardware according to various embodiments of the present disclosure.

Throughout the drawings, it should be noted that like reference numbers are used to depict the same or similar elements, features, and structures.

### DETAILED DESCRIPTION

Detailed descriptions of various aspects of the present disclosure will be discussed below with reference to the attached drawings. The descriptions are set forth as examples only, and shall not limit the scope of the present disclosure.

The detailed description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Unless defined differently, all terms used in the present disclosure, including technical or scientific terms, have meanings that are understood generally by a person having ordinary skill in the art. Ordinary terms that may be defined in a dictionary should be understood to have the meaning consistent with their context, and unless clearly defined in the present disclosure, should not be interpreted to be excessively idealistic or formalistic.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an MP3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

Various embodiments of the present disclosure include a method of providing portable and personalized infotainment via an in-vehicle system of a vehicle from an infotainment content provider.

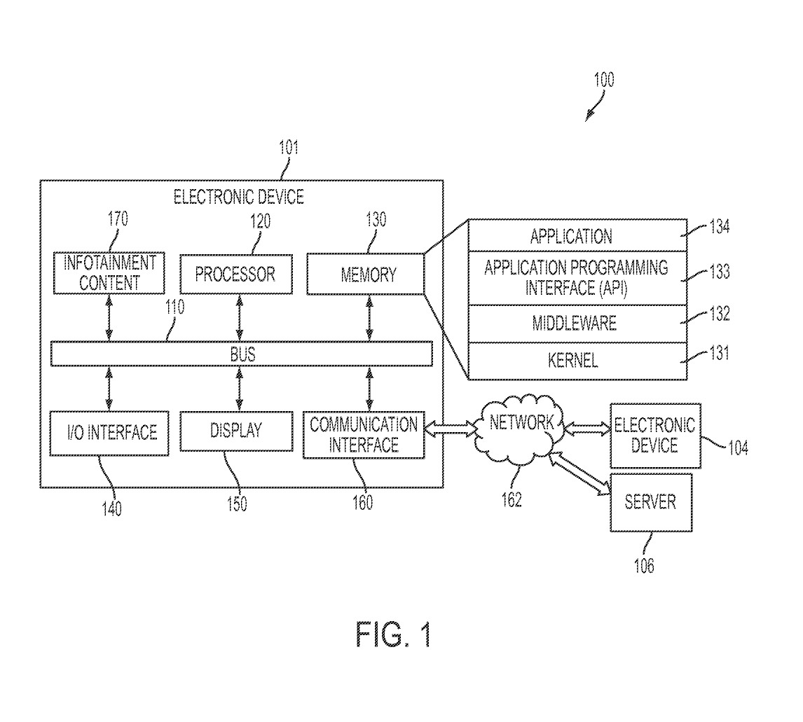

FIG. 1 illustrates a network environment including an electronic device according to various embodiments of the present disclosure.

Referring to FIG. 1, a network environment 100 includes an electronic device 101. The electronic device 101 may include a bus 110, a processor 120, a memory 130, an Input/Output (I/O) interface 140, a display 150, a communication interface 160, an infotainment content 170, and/or the like.

The bus 110 may be circuitry that connect the foregoing components and allow communication between the foregoing components. For example, the bus 110 may connect components of the electronic device 101 so as to allow control messages and/or other information to be communicated between the connected components.

The processor 120 may, for example, receive instructions from other components (e.g., the memory 130, the I/O interface 140, the display 150, the communication interface 160, the infotainment content 170, and/or the like), interpret the received instructions, and execute computation or data processing according to the interpreted instructions.

The memory 130 may, for example, store instructions and/or data that are received from, and/or generated by, other components (e.g., the memory 130, the I/O interface 140, the display 150, the communication interface 160, the infotainment content module 170, and/or the like). For example, the memory 130 may include programming modules such as a kernel 131, a middleware 132, an Application Programming Interface (API) 133, an application 134, and/or the like. Each of the foregoing programming modules may include a combination of at least two of software, firmware, or hardware.

The kernel 131 may control or manage system resources (e.g., the bus 110, the processor 120, the memory 130, and/or the like) that may be used in executing operations or functions implemented in other programming modules such as, for example, the middleware 132, the API 133, the application 134, and/or the like. The kernel 131 may provide an interface for allowing or otherwise facilitating the middleware 132, the API 133, the application 134, and/or the like, to access individual components of electronic device 101.

The middleware 132 may be a medium through which the kernel 131 may communicate with the API 133, the application 134, and/or the like to send and receive data. The middleware 132 may control (e.g., scheduling, load balancing, and/or the like) work requests by one or more applications 134. For example, the middleware 132 may control work requests by one or more applications 134 by assigning priorities for using system resources (e.g., the bus 110, the processor 120, the memory 130, and/or the like) of electronic device 101 to the one or more applications 134.

The API 133 may be an interface that may control functions that the application 134 may provide at the kernel 131, the middleware 132, and/or the like. For example, the API 133 may include at least an interface or a function (e.g., command) for file control, window control, video processing, character control, and/or the like.

According to various embodiments of the present disclosure, the application 134 may include a Short Message Service (SMS) application, a Multimedia Messaging Service (MMS) application, an email application, a calendar application, an alarm application, a health care application (e.g., an exercise amount application, a blood sugar level measuring application, and/or the like), an environmental information application (e.g., an application that may provide atmospheric pressure, humidity, temperature information, and/or the like), an instant messaging application, a call application, an internet browsing application, a gaming application, a media playback application, an image/video capture application, a file management application, and/or the like. In addition to or as an alternative to, the application 134 may be an application that is associated with information exchange between the electronic device 101 and an external electronic device (e.g., electronic device 104). As an example, the application 134 that is associated with the information exchange may include a notification relay application that may provide the external electronic device with a certain type of information, a device management application that may manage the external electronic device, and/or the like.

As an example, the notification relay application may include a functionality that provides notification generated by other applications at electronic device 101 (e.g., the SMS/MMS application, the email application, the health care application, the environmental information application, the instant messaging application, the call application, the internet browsing application, the gaming application, the media playback application, the image/video capture application, the file management application, and/or the like) to an external electronic device (e.g., the electronic device 104). In addition to or as an alternative to, the notification relay application may provide, for example, receive notification from an external electronic device (e.g., the electronic device 104), and may provide the notification to a user.

As an example, the device management application may manage enabling or disabling of functions associated with least a portion of an external electronic device (e.g., the external electronic device itself, or one or more components of the external electronic device) in communication with electronic device 101, controlling of brightness (or resolution) of a display of the external electronic device, an application operated at, or a service (e.g., a voice call service, a messaging service, and/or the like) provided by, the external electronic device, and/or the like.

According to various embodiments of the present disclosure, as an example, the application 134 may include one or more applications that are determined according to a property (e.g., type of electronic device, and/or the like) of the external electronic device (e.g., the electronic device 104). For example, if the external electronic device is an mp3 player, the application 134 may include one or more applications related to music playback. As another example, if the external electronic device is a mobile medical device, the application 134 may be a health care-related application. According to various embodiments of the present disclosure, the application 134 may include at least one of an application that is preloaded at the electronic device 101, an application that is received from an external electronic device (e.g., the electronic device 104, a server 106, and/or the like), and/or the like.

The I/O interface 140 may, for example, receive instruction and/or data from a user. The I/O interface 140 may send the instruction and/or the data, via the bus 110, to the processor 120, the memory 130, the communication interface 160, the infotainment content module 170, and/or the like. For example, the I/O interface 140 may provide data associated with user input received via a touch screen to the processor 120. The I/O interface 140 may, for example, output instructions and/or data received via the bus 110 from the processor 120, the memory 130, the communication interface 160, the infotainment content module 170, and/or the like, via an I/O device (e.g., a speaker, a display, and/or the like). For example, the I/O interface 140 may output voice data (e.g., processed using the processor 120) via a speaker.

The display 150 may display various types of information (e.g., multimedia, text data, and/or the like) to the user. As an example, the display 150 may display a Graphical User Interface (GUI) with which a user may interact with the electronic device 101.

The communication interface 160 may provide communication between electronic device 101 and one or more external electronic devices (e.g., the electronic device 104, the server 106, and/or the like). For example, the communication interface 160 may communicate with the external electronic device by establishing a connection with a network 162 using wireless or wired communication. As an example, wireless communication with which the communication interface 160 may communicate may be at least one of, Wi-Fi, Bluetooth, Near Field Communication (NFC), Global Positioning System (GPS), cellular communication (e.g., Long Term Evolution (LTE), LTE Advanced (LTE-A), Code Division Multiple Access (CDMA), Wideband-CDMA (WDCMA), Universal Mobile Telecommunications System (UMTS), Wireless Broadband (WiBro), Global System for Mobile Communications (GSM), and/or the like), Infrared Data Association (IrDA) technology, and/or the like. As an example, wired communication with which the communication interface 160 may communicate may be at least one of, for example, Universal Serial Bus (USB), High Definition Multimedia Interface (HDMI), Recommended Standard 232 (RS-232), Plain Old Telephone Service (POTS), Ethernet, and/or the like.

According to various embodiments of the present disclosure, the network 162 may be a telecommunications network. As an example, the telecommunications network may include at least one of a computer network, the Internet, the Internet of Things, a telephone network, and/or the like. According to various embodiments of the present disclosure, a protocol (e.g., a transport layer protocol, a data link layer protocol, a physical layer protocol, and/or the like) for communicating between electronic device 101 and an external electronic device may be supported by, for example, at least one of the application 134, the API 133, the middleware 132, the kernel 131, the communication interface 160, and/or the like.

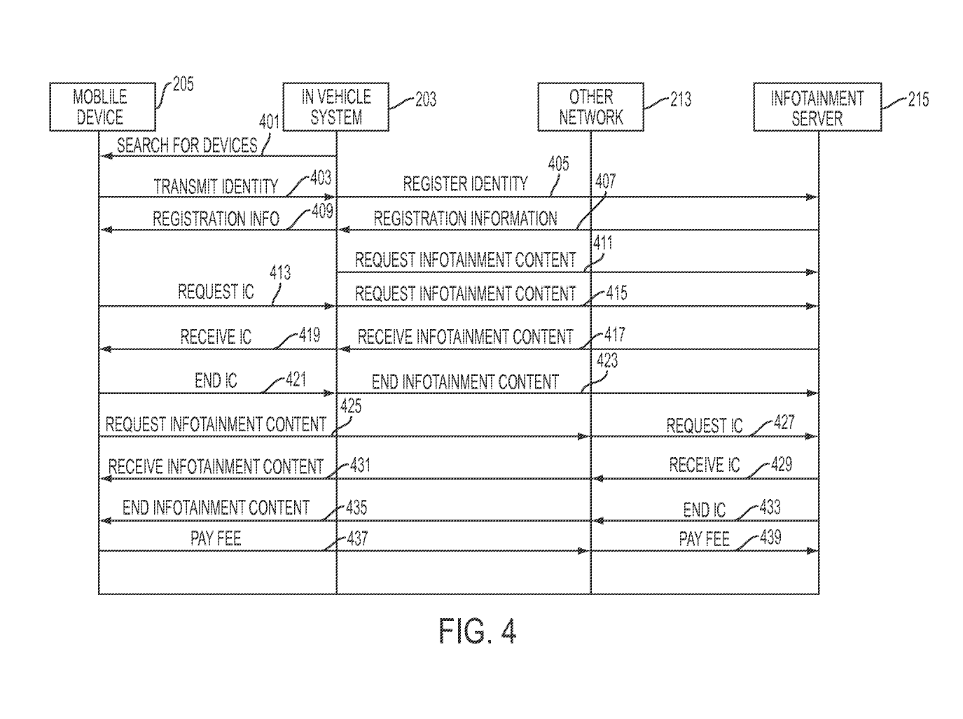

The infotainment content module 170 may, for example, process at least a part of information received from other components (e.g., the processor 120, the memory 130, the I/O interface 140, the communication interface 160, and/or the like), and provide various information, services, and/or the like to the user in various manners. For example, the infotainment content module 170 may control via the processor 120 or independently at least some of the functions of the electronic device 101 to communicate or connect to another electronic device (e.g., the electronic device 104, the server 106, and/or the like). FIG. 4 will provide additional information regarding the infotainment content module 170.

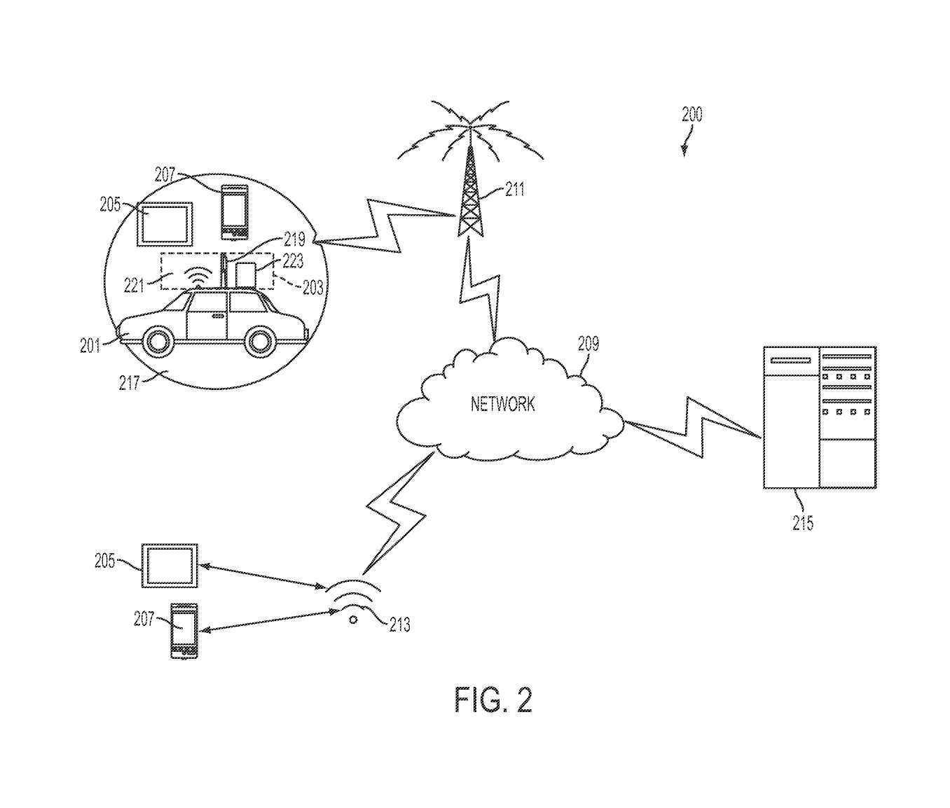

FIG. 2 illustrates a simplified structure of a vehicle infotainment content system according to an embodiment of the present disclosure.

Referring to FIG. 2, a vehicle infotainment content is configured to include a vehicle 201, an in-vehicle system 203, mobile devices 205 and 207, a network 209, a cellular network 211, a home WiFi network 213 and an infotainment content server 215, but is not limited thereto.

The in-vehicle system 203 includes a processing system and sensors 223, a mobile communication system 219 and an in-vehicle hot spot 221. The processing system and sensors 223 are responsible for determining the presence of a user via sensors for determining the presence of a driver and passengers and providing content to the passengers and driver. The processing system and sensors 223 may also collaborate with mobile devices to determine their presences and locations in-vehicle. The mobile communication system 219 provides a connection to the cellular network 211 and is used to transfer data to and from the cellular network 211. The in-vehicle hot spot 221 is used to provide a connection to users within a defined location 217 to the vehicle 201. The in-vehicle hot spot 221 may be a WiFi network, bluetooth or any other conventional communications means for providing communications over short distances.

The vehicle 201 contains occupants who are taking a trip and may have mobile devices 205 and 207. The vehicle 201 contains an in-vehicle system 203 supported. The in-vehicle system may be any of Bluetooth, Near Field Communication (NFC), Wi-Fi, and the like. The mobile devices 205 and 207 may register with the in-vehicle system 203 in manner known to those of ordinary skill in the art. For example, the registration may use a Media Access Control (MAC) address to uniquely identify a device, but is not limited thereto.

For safety reasons, the in-vehicle system 203 differentiates the mobile devices with passengers from the mobile device with the driver. Since passengers may have more freedom to interact with their mobile devices, while the driver is usually restricted from the distractions. Therefore, it is critical for the processing system and sensors 223 to automatically detect the seat of each mobile device. For example, when the mobile device 205 is with one of passengers, this device may receive movies or games from the infotainment server 215. However, if the mobile device 205 is with the driver, then most interactions will be disabled. This seat detection may be achieved in a few different approaches: 1.) install an NFC chip (not illustrated) at each seat, once the mobile device 205 touches the specific NFC, then the mobile device 205 or the in-vehicle system 203 knows which seat the mobile device 205 is currently located inside the vehicle. Then, the mobile device 205 may sync with the infotainment content server 215 to retrieve service appropriate for that seat. This approach requires user's explicit action to touch NFC. 2.) Install Bluetooth Low Energy (BLE) beacons or receivers around each seat. The processing system and sensors 223 may collaborate with the mobile device and use the signal from all beacons or receivers to determine the specific seat of this mobile device. For example, the mobile device may use the relative signal strength received from multiple beacons to estimate its own relative location. Alternatively, the mobile device may broadcast a signal to all receivers in 223, and then the processing system can estimate the device's location from the received signals. There are many known localization methods and those are omitted herein. 3.) Using biometric sensors to correlate the seat and the mobile device. For example, a heartbeat sensor sheet (EMFi sensor) (not illustrated) with each seat in the vehicle 201. The processing system and sensors 223 may correlate the heartbeat detected from the seat and the heartbeat detected from passenger's the mobile device 205, the processing system and sensors 223 will know exactly which seat the user of the mobile device 205 is sitting at.

The processing system and sensors 223 may precisely determine whether the mobile device 205 is inside or outside of the vehicle 201. Such determination may avoid accidently providing infotainment content to individuals who happen to be near the vehicle 201, but are not intended passengers. This detection may be achieved by using a door sensor (not illustrated) installed around the vehicle 201's doors. Alternatively, GPS or other motion sensors may be used to correlate the moving of the vehicle and the mobile devices.

Once the passenger's mobile device 205 has been registered and authenticated, the in-vehicle hotspot 221 may be set up to automatically attach to the passenger's mobile device 205. This may be achieved by a push notification from the infotainment content server 215 once the mobile device 205 is authenticated. The push notification will carry the in-vehicle hotspot credentials. Once receives the notification, the mobile device will automatically connect to the in-car hotspot using this credentials.

The in-vehicle system 203 provides infotainment content that an owner of the vehicle 201 purchases. The infotainment content is received via a cellular network from the cellular network 211 from the infotainment content server 215 and reproduced on a display (not illustrated) of a head unit (not illustrated) of the vehicle 201. In an embodiment of the present disclosure, as the mobile devices 205 and 207 are registered with the in-vehicle system 203 and the vehicle 201 provides infotainment content, the mobile devices 205 and 207 are further registered with the infotainment content server 215. Thus, when the infotainment content is transmitted to the vehicle 201, the infotainment content may be further transmitted via the in-vehicle system 203 to the mobile devices 205 and 207. The mobile devices 205 and 207 are registered with the infotainment content server 215 as they are within a defined location 217 of the vehicle 201, the vehicle 201 receiving the infotainment content as a subscription. The mobile devices 205 and 207 by their presence in the vehicle are provided access to the infotainment content while within the defined location 217 of the vehicle 201 (i.e., within the vehicle) or according to the sensors as described above.

After a period of time, the occupants of the vehicle 201 reach their destination. At that point, the occupants will exit the vehicle 201 and enter, for example, their respective homes with their respective mobile devices 205 and 207. As the mobile devices 205 and 207 are no longer within the defined location 217 of the vehicle 201, the infotainment content server 215 will intend to disconnect their access to the infotainment content via the in-vehicle system 203 through which they are registered and through which the subscription for infotainment content is paid.

The infotainment content server 215 may provide a grace period before the disconnection. The mobile devices 205 and 207 having registered with the infotainment content server 215 may receive the infotainment content for a period of time or for a period related to receipt of the content via another network such as the home WiFi network 213 connected to a network 209, such as the interne. Thus, the mobile devices 205 and 207 may, for example, receive the infotainment content for a period of forty-eight hours after leaving the vehicle 201 and/or be limited to receiving three hours of the infotainment content after leaving the vehicle 201, which ever elapses first. Other time periods may be used as well. For example, if the occupants of the vehicle 201 are watching a movie and leave the car halfway through the movie, they may be allowed to finish watching a remaining fifty-five minutes of the movie any time in the forty-eight hours after leaving the vehicle 201.

After a period of time elapses for receiving infotainment content, the mobile devices 205 and 207 may purchase further time and continue to receive the infotainment content.

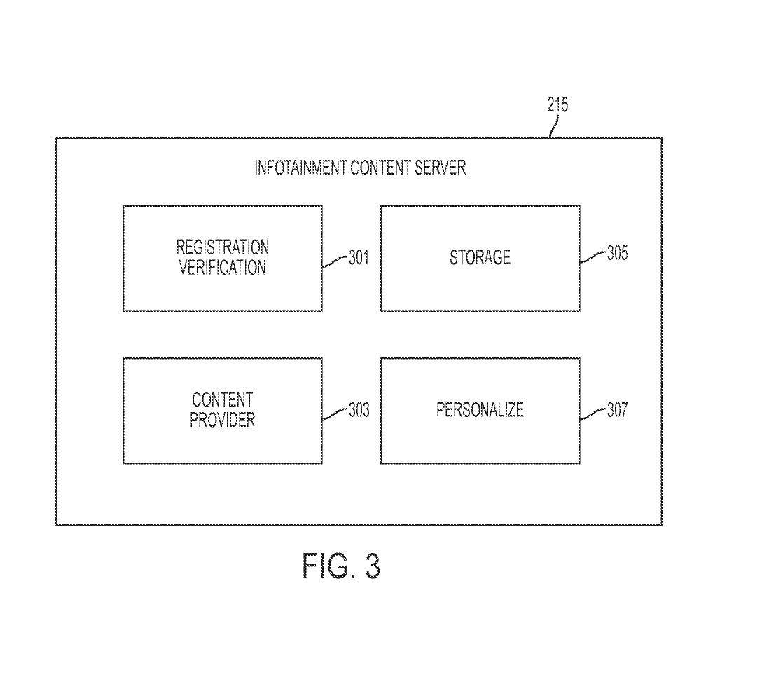

FIG. 3 illustrates an infotainment content server for providing infotainment content according to an embodiment of the present disclosure.

Referring to FIG. 3, an infotainment content server 215 is illustrated. The infotainment content server 215 includes a registration verification module 301, a content provider module 303, a storage module 305 and a personalization module 307.

The registration verification module 301 is a software module used to verify the registration information of mobile devices, such as mobile devices 205 and 207. The registration verification module 301 uniquely verifies each mobile devices 205 and 207 that has registered with the infotainment content server 215. It will be understood that there are any number of unique methods known in the art that may be used to uniquely identify the mobile devices 205 and 207 and the steps of doing so are omitted herein. The registration verification module 301 is responsible for initially registering the mobile devices 205 and 207 when the mobile devices 205 and 207 initially enter the vehicle 201 and later verify the mobile devices 205 and 207 when the mobile devices 205 and 207 attempt to access infotainment content via another network, such as the home WiFi network 213, or enter another vehicle (not illustrated) whose content is provided by the same infotainment content server 215.

Once the registration verification module 301 has either registered or verified the mobile devices 205 and 207, the content provider module 303 may provide content to the mobile devices 205 and 207 either via the in-vehicle system 203 or via another network, for example, home WiFi network 213.

The content provider module 303 provides all types of information or entertainment content, including news, weather, traffic, television shows, movies and the like.

The personalization module 307 keeps track of the infotainment content that the mobile devices 205 and 207 have received. The personalization module 307 uses this information to suggest other infotainment content to the users of the mobile devices 205 and 207 or to the owner of the vehicle 201 who pays for the subscription of the infotainment content system 200.

The storage module 305 stores all the information produced by the processing system and sensors 223 and consumed by the registration verification module 301, the content provider module 303, and the personalization module 307.

FIG. 4 illustrates a network diagram of a vehicle infotainment content system that is capable of connecting with a mobile terminal according to an embodiment of the present disclosure.

Referring to FIG. 4, in an operation 401 the in-vehicle processor or sensors 223 of the vehicle 201 searches for the mobile devices 205 and 207 to register within the defined location 217 of the vehicle 201 or determined to the seat with in the vehicle 201 by the sensors within the vehicle 201. Alternatively, the mobile devices 205 and 207 may make the determination as to location based upon the in-seat or other sensors. Upon locating the mobile devices 205 and 207 being located within the defined location 217, in operation 403 transmit unique information to register the mobile devices 205 and 207 to the infotainment content server 215. It will be understood that operations 403 and 405 may be the same operation, or operation 403 reaches the infotainment server 215 via other network, such as the mobile devices' own cellular connections In operation 407 return the registration information to the in-vehicle system 203 and then in operation 409 transmit the registration information to the mobile devices 205 and 207. Alternatively, operation 409 may return from the infotainment content server 215 via the other network, such as the mobile devices' own cellular connections.

In operation 411, the head unit (not illustrated) of the vehicle 201 requests of the infotainment content server 215 infotainment content for the occupants of the vehicle 201. Alternatively, in operations 413 and 415 each of the mobile devices 205 and 207 may request separate infotainment content of the infotainment content server 215. The request in operations 413 may also reach the infotainment server 215 via the other network, such as the mobile devices' own cellular connections.

In operation 417, the infotainment content server 215 transmits the infotainment content to the in-vehicle system 203 via a cellular network 211. In operation 419, the in-vehicle system 203 transmits the infotainment content to the mobile devices 205 and 207. Alternatively, although less preferable, the mobile devices 205 and 207 may choose to receive content from the infotainment content server 215 via the other network, such as the mobile devices' own cellular connections.

This may be an option in some special cases, such as when the in-vehicle system's data usage is reaching its limit, or when it has limited bandwidth, etc. The mobile devices 205 and 207 continue to receive the infotainment content until they exit the vehicle 201. In operation 421, the mobile devices 205 and 207 exit the car and an end infotainment content message is transmitted to the in-vehicle system 203 and retransmitted to the infotainment content server 215 in operation 423. Alternatively, the operation 421 can talk to the infotainment server 215 via the other network, such as the mobile devices' own cellular connections.

Upon the mobile devices 205 and 207 leaving the vehicle, if they continue to have connections through another network, for example, the home WiFi network 213 or the cellular network 211, the mobile devices 205 and 207 may request to continue receiving the infotainment content in operation 425 by transmitting the request to the other network. The other network in turn, transmits the request to the infotainment content server 215 in operation 427. The infotainment content server 215 after verifying the mobile devices 205 and 207 transmits the infotainment content in operation 429 to the other network. In operation 431, the other network retransmits the infotainment content to the mobile devices 205 and 207.

The infotainment content continues to be transmitted until a defined period of time has expired in operation 433. At that point, the infotainment content server 215 transmits a message that ends the infotainment content by transmitting the message to the other network, in operation 435 to the mobile devices 205 and 207. The message that ends the infotainment content may include other information on payment options or other content that may extend the mobile devices 205 and 207 ability to receive content.

In operation 437, the users of the mobile devices 205 and 207 may provide payment of a fee in operations 437 and 439. The payment of the fee may be in, for example, credit card information or by agreeing to receive offers or commercials for products and, in return, the mobile devices 205 and 207 may continue to receive infotainment content as in operations 429 and 431.

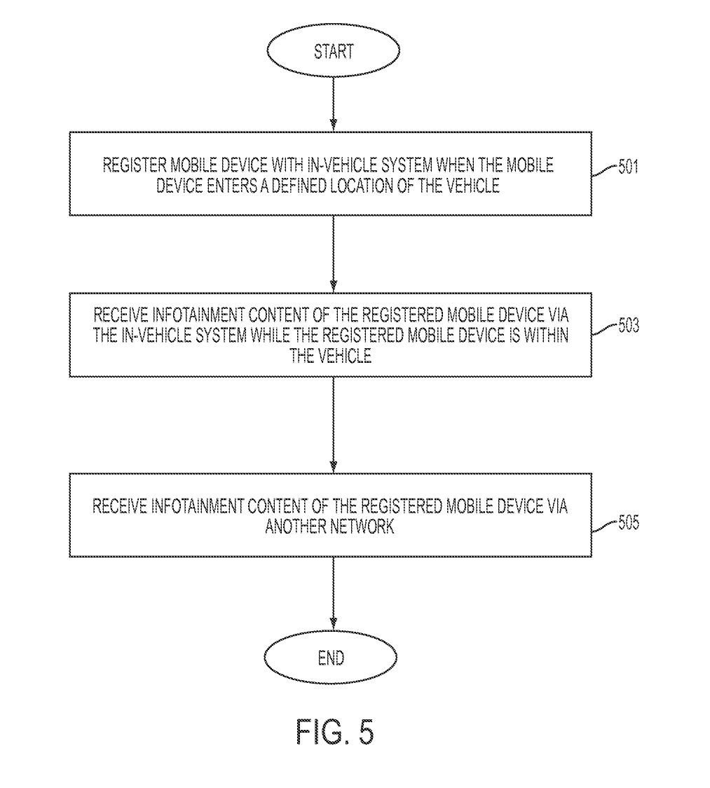

FIG. 5 is a flowchart of a method of providing infotainment content according to an embodiment of the present disclosure.

Referring to FIG. 5, in operation 501 an in-vehicle system 203 of the vehicle 201 registers at least one mobile device 205 and 207 when the at least one mobile device 205 and 207 enters a defined location 217 determines by the in-vehicle processing system and sensors 223 of the vehicle 201. The in-vehicle system 203 of the vehicle 201 in response transmits the registration information to the infotainment content server 215.

In response, in operation 503, the at least one mobile device 205 and 207 receive infotainment content via the in-vehicle system 203 of the vehicle 201 while the at least one mobile device 205 and 207 is within the defined location 217 to the in-vehicle system 203 of the vehicle 201

If the at least one mobile device 205 and 207 leaves the defined location 217 to the in-vehicle system 203 of the vehicle 201, the at least one mobile device 205 and 207 receive infotainment content via another network in operation 505.

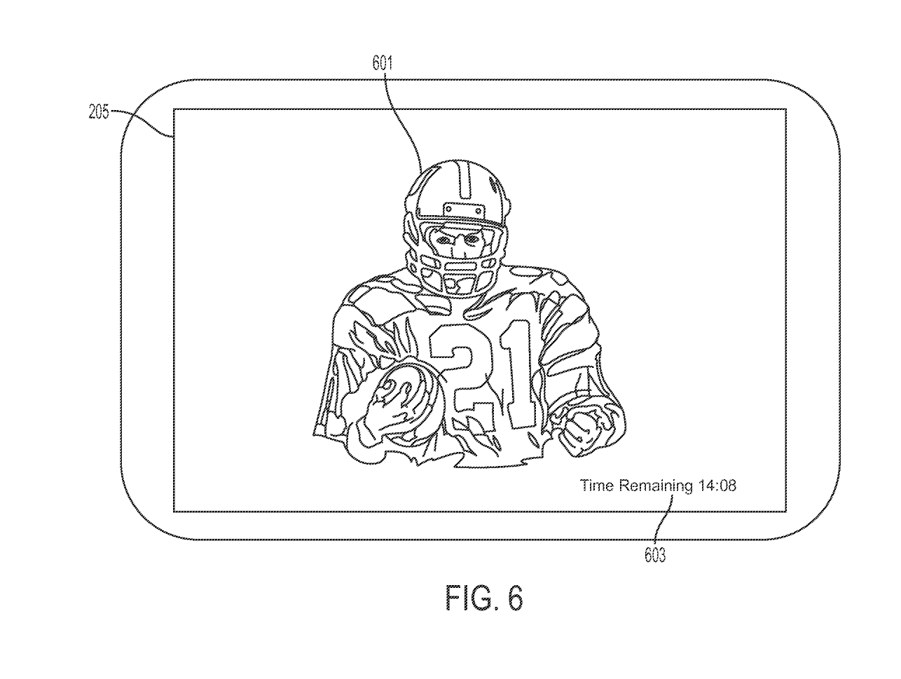

FIG. 6 is an illustration of a mobile device receiving infotainment content according to an embodiment of the present disclosure.

Referring to FIG. 6, the mobile device 205 is receiving a football game 601 as infotainment content. After exiting the vehicle 201, the user of the mobile device 205 enters his or her home where they attach to the home WiFI network 213 or optionally the cellular network 211. When the user of the mobile device 205 requests to continue watching (i.e. receiving infotainment content) the football game 601, the mobile device 205 sends the request via the home WiFI network 213 to the infotainment content server 215 and begins to receive the football game 601 (i.e. receiving infotainment content).

As the mobile device 205 is no longer attached to the in-vehicle system 203 that pays for the subscription of the infotainment content, a message 603 indicates the length of time the user may continue to watch the football game. When the time is up, the mobile device 205 will receive a message that the ability to receive infotainment content has expired.

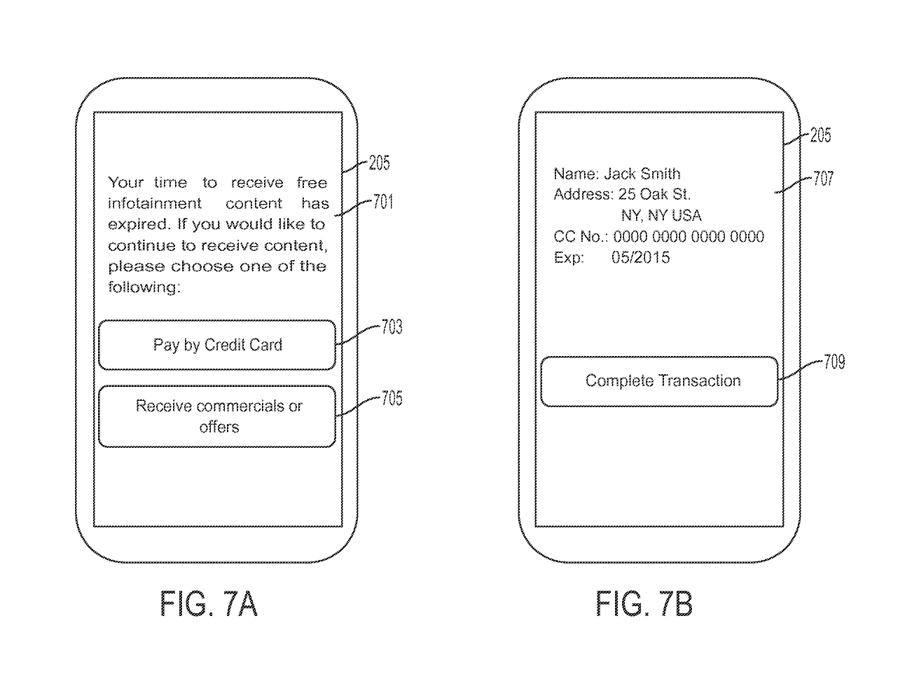

FIGS. 7A and 7B are illustrations of a mobile device responding to an end of receiving infotainment content according to an embodiment of the present disclosure.

Referring to FIGS. 7A and 7B, the mobile device 205 upon expiration of the period for receiving free infotainment content (i.e., the football game 601), receives a message 701 that the period has ended. The message 701 requests that the user make choices in order to continue receiving the infotainment content (i.e., the football game 601). The user may agree either to pay by credit card in operation 703 or to receive commercial content or offers in operation 705.

By example, the user chooses to pay by credit card in operation 703 and then enters his or her credit card information 707. When all the credit card information 707 is entered, the transaction is completed in operation 709 and the credit card information is transmitted to the infotainment content server 215 for verification. Upon verification by the infotainment content server 215, the mobile device 205 again receives infotainment content (i.e., the football game 601).

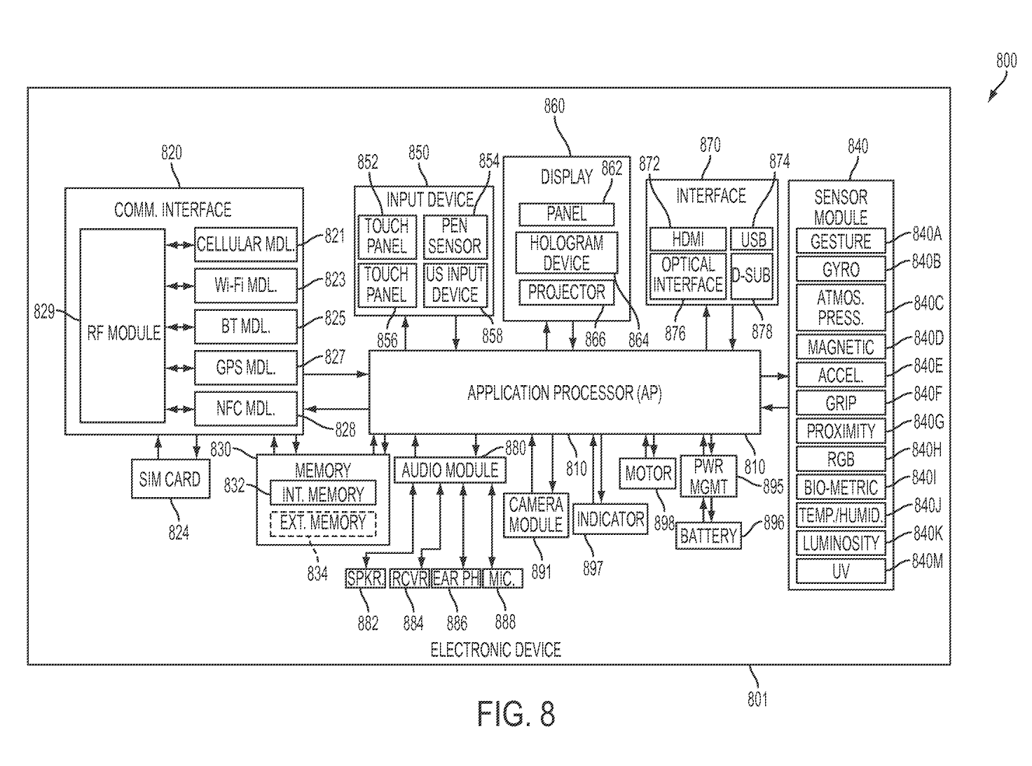

FIG. 8 illustrates a block diagram of hardware according to various embodiments of the present disclosure.

Referring to FIG. 8, hardware 801 may be, for example, a part or the entire part of the electronic device 101. Referring to FIG. 8, the hardware 801 may include one or more Application Processors (AP) 810, a communication module 820, a Subscriber Identification Module (SIM) card 824, a memory 830, a sensor module 840, an input module 850, a display module 860, an interface 870, an audio module 880, a camera module 891, a power management module 895, a battery 896, an indicator 897, a motor 898, and/or the like.

The AP 810 may control one or more hardware or software components that are connected to AP 810, perform processing or computation of data (including multimedia data), and/or the like. As an example, the AP 810 may be implemented as a System-on-Chip (SoC). The AP 810 may include a Graphics Processing Unit (GPU) (not shown).

The communication module 820 (e.g., the communication interface 160) may transmit and receive data in communications between the electronic device 101 and other electronic devices (e.g., the electronic device 104, the server 106, and/or the like). As an example, the communication module 820 may include one or more of a cellular module 821, a Wi-Fi module 823, a Bluetooth module 825, a GPS module 827, a NFC module 828, a Radio Frequency (RF) module 829, and/or the like.

The cellular module 821 may provide services such as, for example, a voice call, a video call, a Short Messaging Service (SMS), interne service, and/or the like, via a communication network (e.g., LTE, LTE-A, CDMA, WCDMA, UMTS, WiBro, GSM, and/or the like). As an example, the cellular module 821 may differentiate and authorize electronic devices within a communication network using a Subscriber Identification Module (SIM) card (e.g., the SIM card 824). According to various embodiments of the present disclosure, the cellular module 821 may perform at least a part of the functionalities of the AP 810. For example, the cellular module 821 may perform at least a part of multimedia control functionality.

According to various embodiments of the present disclosure, the communication interface 820 and/or the cellular module 821 may include a Communication Processor (CP). As an example, the cellular module 821 may be implemented as SoC.

Although FIG. 8 illustrates components such as the cellular module 821 (e.g., CP), the memory 830, the power management module 895 as components that are separate from the AP 810, according to various embodiments of the present disclosure, the AP 810 may include, or be integrated with, one or more of the foregoing components (e.g., the cellular module 821).

According to various embodiments of the present disclosure, the AP 810, the cellular module 821 (e.g., CP), and/or the like, may process instructions or data received from at least one of non-volatile memory or other components by loading in volatile memory. The AP 810, the cellular module 821, the communication interface 820, and/or the like, may store at non-volatile memory at least one of data that is received from at least one of other components or data that is generated by at least one of the other components.

Each of the Wi-Fi module 823, the Bluetooth module 825, the GPS module 827, the NFC module 828, and/or the like may, for example, include one or more processors that may process data received or transmitted by the respective modules. Although FIG. 8 illustrates the cellular module 821, the Wi-Fi module 823, the Bluetooth module 825, the GPS module 827, and the NFC module 828 as separate blocks, according to various embodiments of the present disclosure, any combination (e.g., two or more) of the cellular module 821, the Wi-Fi module 823, the Bluetooth module 825, the GPS module 827, the NFC module 828, and/or the like may be included in an Integrated Chip (IC) or an IC package. For example, at least some of the processors corresponding to the respective the cellular module 821, the Wi-Fi module 823, the Bluetooth module 825, the GPS module 827, the NFC module 828, and/or the like, may be implemented as a single SoC. For example, a CP corresponding to the cellular module 821 and a Wi-Fi processor corresponding to Wi-Fi module 823 may be implemented as a single SoC.

The RF module 829 may, for example, transmit and receive RF signals. Although not shown, the RF module 829 may include a transceiver, a Power Amp Module (PAM), a frequency filter, a Low Noise Amplifier (LNA), and/or the like. The RF module 834 may include one or more components for transmitting and receiving Electro-Magnetic (EM) waves (e.g., in free space or the like) such as, for example, conductors or conductive wires. Although FIG. 8 illustrates that the cellular module 821, the Wi-Fi module 823, the Bluetooth module 825, the GPS module 827, and the NFC module 828 are sharing one RF module 829, according to various embodiments of the present disclosure, at least one of the cellular module 821, the Wi-Fi module 823, the Bluetooth module 825, the GPS module 827, the NFC module 828, and/or the like may transmit and receive RF signals via a separate RF module.

The SIM card 824 may be a card implementing a SIM, and may be configured to be inserted into a slot disposed at a specified location of the electronic device. The SIM card 824 may include a unique identifier (e.g., Integrated Circuit Card IDentifier (ICCID)) subscriber information (e.g., International Mobile Subscriber Identity (IMSI)), and/or the like.

The memory 830 (e.g., memory 130) may include an internal memory 832, an external memory 834, or a combination thereof.

According to various embodiments of the present disclosure, the internal memory 832 may be, for example, at least one of volatile memory (e.g., Dynamic Random Access Memory (DRAM), Static Random Access Memory (SRAM) or Synchronous Dynamic Random Access Memory (SDRAM)), non-volatile memory (e.g., One Time Programmable Read Only Memory (OTPROM), Programmable Read Only Memory (PROM), Erasable and Programmable Read Only Memory (EPROM), Electrically Erasable and Programmable Read Only Memory (EEPROM), mask Read Only Memory (ROM), flash ROM, NAND flash memory, NOR flash memory), and/or the like.

According to various embodiments of the present disclosure, the internal memory 832 may be a Solid State Drive (SSD). As an example, the external memory 834 may be a flash drive (e.g., Compact Flash (CF drive), Secure Digital (SD), micro Secure Digital (micro-SD), mini Secure Digital (mini-SD), extreme Digital (xD), Memory Stick, and/or the like). The external memory 834 may be operatively coupled to electronic device 801 via various interfaces. According to various embodiments of the present disclosure, the electronic device 801 may include recording devices (or recording media) such as, for example, Hard Disk Drives (HDD), and/or the like.

The sensor module 840 may measure physical/environmental properties detect operational states associated with electronic device 801, and/or the like, and convert the measured and/or detected information into signals such as, for example, electric signals or electromagnetic signals. As an example, the sensor module 840 may include at least one of a gesture sensor 840A, a gyro sensor 840B, an atmospheric pressure sensor 840C, a magnetic sensor 840D, an accelerometer 840E, a grip sensor 840F, a proximity sensor 840G, an RGB sensor 840H, a biometric sensor 840I, a temperature/humidity sensor 840J, a luminosity sensor 840K, a Ultra Violet (UV) sensor 840M, and/or the like. The sensor module 840 may detect the operation state of the electronic device and/or measure physical properties, and convert the detected or measured information into electrical signals. Additionally or alternatively, the sensor module 840 may also include, for example, an electrical-nose sensor (not shown), an electromyography (EMG) sensor (not shown), an electroencephalogram (EEG) sensor (not shown), an infrared (IR) sensor (not shown), an eye-scanning sensor (e.g., iris sensor) (not shown), a fingerprint sensor, and/or the like. The sensor module 840 may also include control circuitry for controlling one or more sensors included therein.

The input module 850 may include a touch panel 852, a (digital) pen sensor 854, a key 856, an ultrasonic input device 858, and/or the like.

As an example, the touch panel 852 may detect touch input using capacitive, resistive, infrared, ultrasonic methods, and/or the like. The touch panel 852 may also include a touch panel controller (not shown). As an example, a capacitive-type touch panel may detect proximity inputs (e.g. hovering input) in addition to, or as an alternative to, physical touch inputs. The touch panel 852 may also include a tactile layer. According to various embodiments of the present disclosure, the touch panel 852 may provide haptic feedback to the user using the tactile layer.

As an example, the (digital) pen sensor 854 may be implemented using methods identical to or similar to receiving a touch input from a user, or using a separate detection sheet (e.g., a digitizer).

As an example, the key 856 may be a keypad, a touch key, and/or the like.

As an example, the ultrasonic input device 858 may be a device configured to identify data by detecting, using a microphone (e.g., microphone 888), ultrasonic signals generated by a device capable of generating the ultrasonic signal. The ultrasonic input device 858 may detect data wirelessly.

According to various embodiments of the present disclosure, the electronic device 801 may receive user input from an external device (e.g., a network, computer or server) connected to the electronic device 801 using the communication module 820.

The display module 860 (e.g., display 150) may include a panel 862, a hologram device 864, a projector 866, and/or the like. As an example, the panel 862 may be, for example, a Liquid-Crystal Display (LCD), an Active-Matrix Organic Light-Emitting Diode (AM-OLED) display, and/or the like. As an example, the panel 862 may be configured to be flexible, transparent, and/or wearable. The panel 862 and the touch panel 852 may be implemented as a single module. The hologram device 864 may provide a three-dimensional image. For example, the hologram device 864 may utilize the interference of light waves to provide a three-dimensional image in empty space. The projector 866 may provide image by projecting light on a surface (e.g., a wall, a screen, and/or the like). As an example, the surface may be positioned internal or external to electronic device 801. According to various embodiments of the present disclosure, the display module 860 may also include a control circuitry for controlling the panel 862, the hologram device 864, the projector 866, and/or the like.

The interface 870 may include, for example, one or more interfaces for a High-Definition Multimedia Interface (HDMI) 872, a Universal Serial Bus (USB) 874, a projector 876, or a D-subminiature (D-sub) 878, and/or the like. As an example, the interface 870 may be part of the communication interface 820. Additionally or alternatively, the interface 870 may include, for example, one or more interfaces for Mobile High-definition Link (MHL), Secure Digital (SD)/MultiMedia Card (MMC), Infrared Data Association (IrDA), and/or the like.

The audio module 880 may encode/decode sound into electrical signal, and vice versa. According to various embodiments of the present disclosure, at least a portion of audio module 880 may be part of the I/O interface 140. As an example, the audio module 880 may encode/decode voice information that is input into, or output from, the speaker 882, the receiver 884, the earphone 886, the microphone 888, and/or the like.

The camera module 891 may capture still images and/or video. According to various embodiments of the present disclosure, the camera module 891 may include one or more image sensors (e.g., front sensor module, rear sensor module, and/or the like) (not shown), an Image Signal Processor (ISP) (not shown), or a flash (e.g., Light-Emitting Diode (flash LED), xenon lamp, and/or the like) (not shown).

The power management module 895 may manage electrical power of the electronic device 801. Although not shown, the power management module 895 may include, for example, a Power Management Integrated Circuit (PMIC), a charger Integrated Circuit (charger IC), a battery gauge, a fuel gauge, and/or the like.

As an example, the PMIC may be disposed in an integrated circuit or an SoC semiconductor. The charging method for the electronic device 801 may include wired or wireless charging. The charger IC may charge a battery, may prevent excessive voltage or excessive current from a charger from entering the electronic device 801, and/or the like. According to various embodiments of the present disclosure, the charger IC may include at least one of a wired charger IC or a wireless charger IC. As an example, the wireless charger IC may be a magnetic resonance type, a magnetic induction type, an electromagnetic wave type, and/or the like. As an example, the wireless charger IC may include circuits such as a coil loop, a resonance circuit, a rectifier, and/or the like.

As an example, the battery gauge may measure a charge level, a voltage while charging, a temperature of battery 896, and/or the like.

As an example, the battery 896 may supply power to the electronic device 801. As an example, the battery 896 may be a rechargeable battery, a solar battery, and/or the like.

The indicator 897 may indicate one or more states (e.g., boot status, message status, charge status, and/or the like) of the electronic device 801 or a portion thereof (e.g., AP 810). Motor 898 may convert an electrical signal into a mechanical vibration.

Although not shown, the electronic device 801 may include one or more devices for supporting mobile television (mobile TV) (e.g., a Graphics Processing Unit (GPU)), and/or the like. The devices for supporting mobile TV may support processing of media data compliant with, for example, Digital Multimedia Broadcasting (DMB), Digital Video Broadcasting (DVB), media flow, and/or the like.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents. Various embodiments of the present disclosure are described as examples only and are noted intended to limit the scope of the present disclosure. Accordingly, the scope of the present disclosure should be understood as to include any and all modifications that may be made without departing from the technical spirit of the present disclosure.

What is claimed is:

1. A method of providing portable and personalized infotainment via an in-vehicle system of a vehicle from an infotainment content provider, the method comprising:
registering at least one mobile device with the in-vehicle system of the vehicle upon the at least one mobile device entering a defined location about the vehicle;
receiving infotainment content at the at least one registered mobile device via the local system of the vehicle while the at least one registered mobile device is within the defined location about the vehicle; and
receiving the infotainment content at the at least one registered mobile device via another network upon the at least one mobile device leaving the defined location about the vehicle.

2. The method of claim 1, wherein each of the at least one registered mobile devices receives individualized broadcast content via the in-vehicle system of the vehicle.

3. The method of claim 1, wherein each of the at least one registered mobile devices receives a same broadcast content as every other of the at least one registered mobile devices via the in-vehicle system of the vehicle.

4. The method of claim 1, wherein the registering of the at least one registered mobile device with the 1 in-vehicle system of the vehicle further comprises:
uniquely identifying the at least one mobile device; and
transmitting information uniquely identifying the at least one registered mobile device to the infotainment content provider.

5. The method of claim 1, further comprising:
monitoring the received infotainment content of the at least one registered mobile device.

6. The method of claim 5, wherein each of the at least one registered mobile devices provides the monitored received content as a recommendation to another of the at least one registered mobile devices.

7. The method of claim 1, wherein the receiving of the infotainment content at the at least one registered mobile device via another network occurs for a defined period.

8. The method of claim 1, wherein, after the defined period, the at least one registered mobile device may re-register directly with the infotainment content provider.

9. The method of claim 1, wherein the defined location about the vehicle is determined by at least one of a sensor or a range of an in-vehicle communications device.

10. A system for providing portable and personalized infotainment, the system comprising:
an in-vehicle system comprising a processor and sensor, the in-vehicle system configured to determine an entry of at least one of a passenger and a driver of a vehicle and to identify a mobile device of the at least one of the passenger and the driver; and
an infotainment server configured to receive information of the mobile device and register the mobile device and to transmit infotainment content to the mobile device, a type of infotainment content transmitted to the mobile device determined based upon whether the user of the mobile device is one of a passenger and a driver of the vehicle,
wherein the mobile device receives the infotainment content via the in-vehicle system while the mobile device is within the vehicle, and
wherein the mobile device receives the infotainment content via another network when the mobile device is outside of the vehicle.

11. The system of claim 10, wherein the mobile device receives a same broadcast content as every registered mobile device via the in-vehicle system.

12. The system of claim 10, wherein the infotainment server is further configured to monitor the received infotainment content of the mobile device.

13. The system of claim 12, wherein the infotainment server is further configured to provide a recommendation to another mobile device based upon the monitored infotainment content of the mobile device.

14. The system of claim 10, wherein the receiving of the infotainment content at the mobile device via another network occurs for a defined period.

15. The system of claim 14, wherein, after the defined period, the mobile device may re-register directly with the infotainment content server.

16. The system of claim 10, wherein, the entry of the at least one passenger into the vehicle is determined by at least one of a sensor or a range of an in-vehicle communications device.

17. The system of claim 16, wherein least one of a sensor is attached to one of a door of the vehicle and a seat of the vehicle.
